(19) United States
(12) Patent Application Publication
(10) Pub. No.: US 2003/0146703 A1
(43) Pub. Date: Aug. 7, 2003

(54) Inner conductor for a co-axial gyrotron with axial corrugations which are evenly distributed around the periphery

(76) Inventor: Olgierd Dumbrajs, Espoo (FI)

Correspondence Address: KLAUS J. BACH & ASSOCIATES, PATENTS AND TRADEMARKS, 4407 TWIN OAKS LANE, MURRYSVILLE, PA, 15668, US

(21) Appl. No.: 10/367,054

(22) Filed: Feb. 14, 2003

Related U.S. Application Data
(63) Continuation-in-part of application No. PCT/EP01/08506, filed on Jul. 24, 2001.

(30) Foreign Application Priority Data
Aug. 17, 2000 (DE) 100 40 320.4

(51) Int. Cl. H01J 25/00

(52) U.S. Cl. 315/4

(57) ABSTRACT

In an inner conductor of a coaxial gyrotron, which inner conductor is disposed on the cathode of the gyrotron and includes an entrance funnel, a center part and an exit funnel, axial corrugations are formed in the conductor by axial grooves formed into its wall such that they begin at the end of the entrance funnel and have, in the center part, an increasing depths up to the exit funnel, in which the depth again becomes steadily smaller, the corrugations being evenly distributed about the inner circumference of the inner conductor.

This is a Continuation-In-Part application of international patent application PCT/EP01/08506 filed Jul. 24, 2001 and claiming the priority of German application No. 100 40 320.4 filed Aug. 17, 2000.

### BACKGROUND OF THE INVENTION

The invention relates to an inner conductor of a co-axial gyrotron with axial corrugations distributed uniformly around the periphery. The metallic electrically conductive inner conductor begins at the front of the cathode and extends beyond the whole resonator space of the gyrotron.

The corrugations can be considered to be an area with two co-axial inner conductors of different diameters. They serve for the mode selection.

Corrugations at the inner conductor with constant depth are known in the art [1]. Such a structure with constant depth permits in a limited way, to manipulate the course of particular mode functions in axial direction.

Based on this state of the art, it is the object of the present invention to improve the mode selection in the resonator of a co-axial gyrotron in such a way that a technical utilization of a gyrotron with such a corrugated inner conductor is technically attractive.

### SUMMARY OF THE INVENTION

In an inner conductor of a coaxial gyrotron, which inner conductor is disposed on the cathode of the gyrotron and includes an entrance funnel, a center part and an exit funnel, axial corrugations are formed in the conductor by axial grooves formed into its wall such that they begin at the end of the entrance funnel and have in the center part an increasing depths up to the exit funnel in which the depth again becomes steadily smaller, the corrugations being evenly distributed about the inner circumference of the inner conductor.

Important is that the corrugations become monotonously deeper toward the center part of the resonator starting from the area of the entrance funnel of the center part of the resonator up to the end of the center part of the resonator. From here on the corrugations in the area of the outlet funnel have a uniformly decreasing depth. “Uniformly” means that the corrugations may start out smooth may remain smooth and end smooth.

The deepening corrugations at the inner conductor in the area of the inlet funnel and the center area permit to influence the course of the individual value functions of the modes in axial direction additionally in a selective manner to increase the start-up currents of undesirable modes, to increase the operating field of the operating mode and also to improve the efficiency of the gyrotron. With this measure, the small losses in the inner conductor in axial direction are homogenized and their cooling is facilitated thereby.

The invention will be described below in greater detail on the basis of the accompanying drawings.

### BRIEF DESCRIPTION OF THE DRAWINGS

FIG. 1a is a schematic cross-sectional view of a gyrotron with an inner conductor,

FIG. 1b shows the inner conductor in cross-section,

FIG. 2a shows the selective influence of the field profile and the grade depending on depth,

FIG. 2b shows the influence on the field profile and the grade at constant depth,

FIG. 3a shows the output energy with variable depth,

FIG. 3b shows the output energy a constant depth, and

FIG. 4 shows the wall losses in the inner conductor in axial (z-) direction.

### DESCRIPTION OF A PARTICULAR EMBODIMENT

The influence of the co-axial inner conductor with corrugations deepening toward the end installed into a high power gyrotron is compared with that of an inner conductor with constant corrugation depth to indicate the power capability of the arrangement, according to the invention with regard to power output of a particular mode. The inner conductor consists in this case of massive copper. Other materials with good electrical conductivity or metallic material compositions or a copper coating of the required thickness on a mechanically strong carrier material such as stainless steel can be used if the operating conditions can be maintained thereby within a given frame.

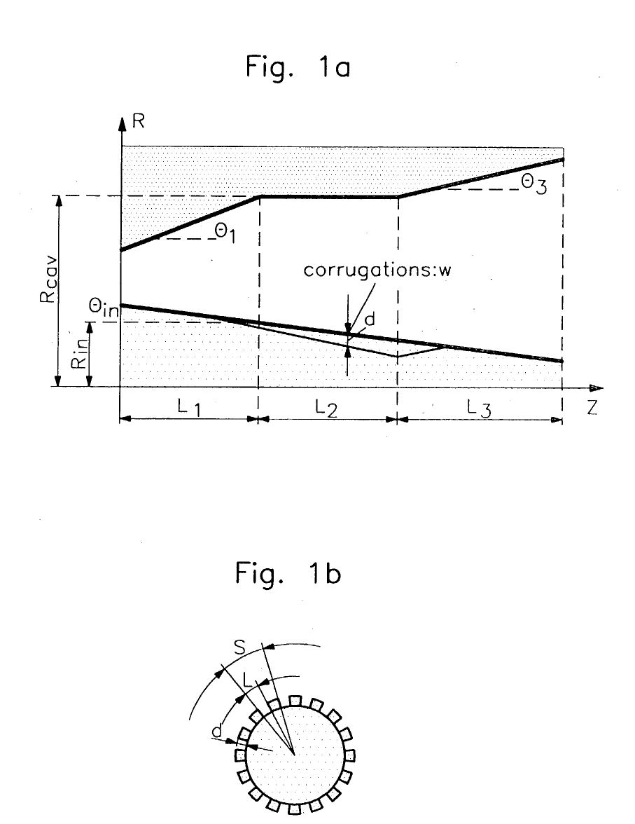

The geometry of the co-axial resonator with impedance corrugations on the inner conductor is shown schematically in FIG. 1a in an axial cross-section taken along the longitudinal axis of the gyrotron. The area of the resonator extends over the inlet funnel L₁—in technical terms also called entrance taper—the center part L₂ of the resonator and the exit funnel L₃, correspondingly called exit taper of the resonator. The attachment of the inner conductor at one end to the cathode of the gyrotron is not shown. It is screwed thereto in a fluid-tight manner if a forced cooling circuit is provided through the cathode to the attachment.

If necessary because of the position of the gyrotron and possible problematic weight mechanics the inner conductor can be mounted and centered also at its collector end outside the electron radiation area toward the collector by means of an insulator star. These are measures, which do not require any extraordinary efforts and expenses.

Since the gyrotron is rotational symmetrical with respect to its longitudinal axis, only half of a cross-section- along its rotational axis is shown.

The inner wall of the entrance taper L₁ tapers outwardly in the z-direction at an angle Θ₁ toward the hollow cylindrical central area, that is the center part L₂ of the resonator. The interior wall of the resonator has a radius R_{cav} over the length L₂, which is followed by the exit taper L₃ which tapers outwardly in z-direction over the length L₃ at an angle Θ₃ toward the collector.

The co-axial inner conductor has a shape, which, in the area of the resonator, is conically pointed toward the collector of the gyrotron at an angle Θᵢₙ. At the end of the entrance taper L₁ or at the beginning of the center area L₂, the inner conductor has the radius Rᵢₙ which is determining for its dimensioning.

The corrugations distributed uniformly over the circumference start at the beginning of the entrance taper L₁ in the zone which is not yet important with respect to the electromagnetic interaction. They extend continuously in an axial direction toward the end of the center part L₂ while becoming monotonously deeper. With the beginning of the zone L₃, that is the exit taper, the depth of the corrugations becomes continuously less and reached zero in at least a proportional progression.

The depth of the corrugations in the inner conductor is not only determined by physics, it is also a question of production expenses. Based on the theoretically correct or most advantageous course d=f(z) of the monotonous deepening, the corrugations are manufactured with compromise. The linear deepening is the simplest manufacturing procedure. The nonlinear, but still monotonous deepening is more complicated but can be achieved with numerically controlled manufacturing tools at acceptable expenses.

FIG. 1b is a cross-sectional view of the inner conductor in the center area L₂ of the resonator. The depth of the corrugations increases up to the end of the center area L₂ with respect to the outer diameter in a monotonous manner as pointed out earlier. In the example, the gyrotron is designed for a frequency of 165 GHz (=1.82 mm wavelength) In gryotrons designed for a different frequency, the geometry changes accordingly on a microwave-technical basis.

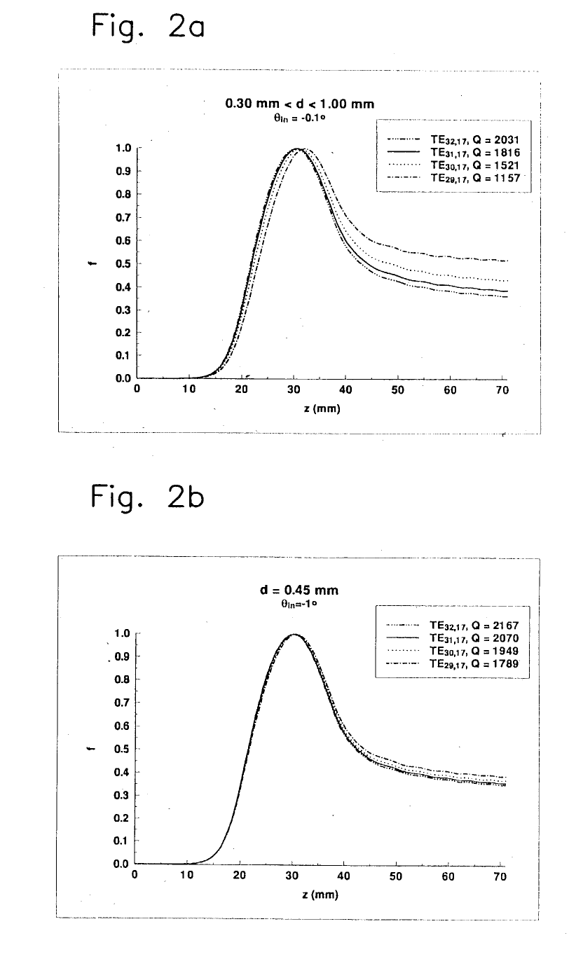

At the bottom of FIGS. 2a and 2b and also 3a and 3b, the dimensions are shown. The representations of FIGS. 2a and 2b are normalized. The absolute values of the grade are indicated in the box with respect to the mode developed. If the corrugation depth d increases half the opening angle Θᵢₙ of the conical inner conductor is only 0.1°. With an inner conductor with constant corrugation depth, the angle Θₘ is 1°.

At this point, for a better overview, the exemplary geometry of the inner conductor in the resonator area is presented in summary since the FIGS. 1a and 1b are not to scale:

In this example the gyrotron is designed for 165 GHz; the inner conductor is formed of massive copper. It is cut out of a solid copper body; the radius of the inner conductor at the beginning of the center area L₂ is Rᵢₙ=7.51 mm; the inner conductor extends conically with half a cone angle of Θₘ=0.1°.

The resonator has an overall length L₁+L₂+L₃=65.5 mm and is divided into the entrance taper with L₁=19 mm, the center area with. L₂=16.5 mm and the exit taper with L₃=30 mm.

The depth d of the corrugations at the inner conductor increases linearly from 0.3 mm at the end of the entrance taper to 0.45 mm at the end of the center area, in short:

0.3 mm<d<1.0 mm between 19 mm<z<35.5 mm in the center area L₂ (see also the values given in FIG. 2a);

the entrance taper has half an opening angle of Θ₁=3°,

the radius in the center area is R_{cav}=27.38 mm and half the opening angle of the exit taper is Θ₃=1.5°.

The essential dimensions of the inner conductor with constant corrugation depth and otherwise the same resonator geometry are indicated in FIG. 2b.

For the electromagnetic interaction, the depth pattern d=f(2) of the corrugations and half the opening or cone angle Θᵢₙ in the center part L₂, that is of the geometry of the inner conductor is important. The course d=f(z) of the corrugation depth in the areas L₁ and L₃ is of little importance as far as the electromagnetic interaction is concerned. It has little influence outside the center area L₂.

FIG. 2a shows the selective influence of the variable depth d on the field profile and the grade. Because of the small grade of the TE_{29,17}-mode, this mode is not excited.

FIG. 2b shows the field profile and the grade of TE_{32,17}-, TE_{31,17-, TE}_{30,17}- and TE_{29,11}-modes in the resonator with a co-axial and conical inner conductor with slots of constant depth d=0.45 mm and half an opening angle Θᵢₙ=1°. Field profiles and grade of all four modes are essentially the same. This means that also the start currents and the excitation probabilities of the modes are the same. This is the major difference from the inner conductor with non-constant, but linearly increasing depth d of the corrugations.

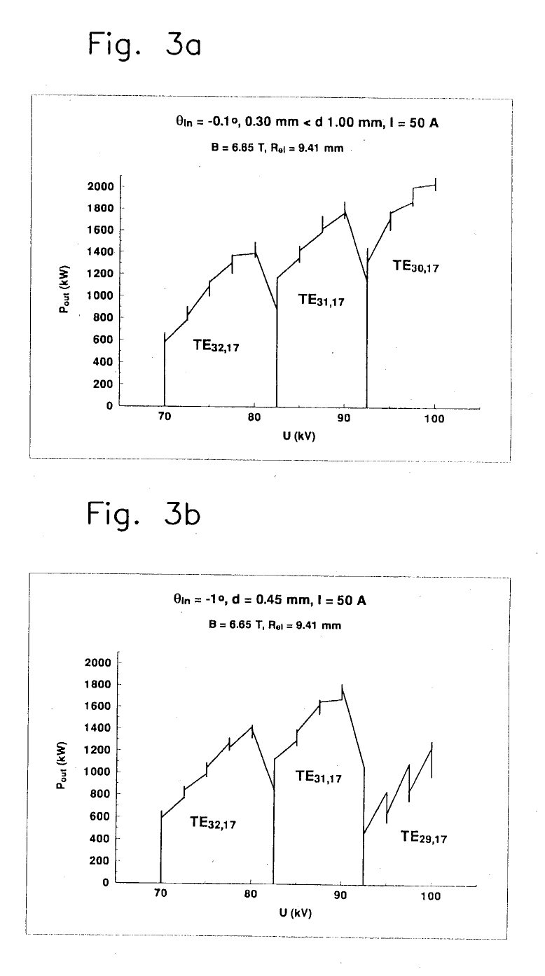

FIGS. 3a and 3b show the output power Pₒᵤₜ in KW depending on the voltage U in kV. In the mode comparison, the effect of the variable corrugation depth 0.3 mm<d<1 mm is apparent also in the power output. As expected, the TE_{29,17}-mode is suppressed. The gyrotron vibrates in the advantageous TE_{30,17}-mode which results in substantially higher power output. About 2000 kW (FIG. 3a), as compared with only about 1200 kW (FIG. 3b) for an inner conductor with constant corrugations depth d=0.45 mm. The mode comparison is disadvantageous. At high voltages, the TE_{29,17}-mode is excited which results in a lower power output. The other values in this comparison were:

the current I=50 A,

the magnetic field in the resonator space B=6.65 T and the radius Fₑ₁=9.41 mm (see also entry in the FIGS. 3a and 3b).

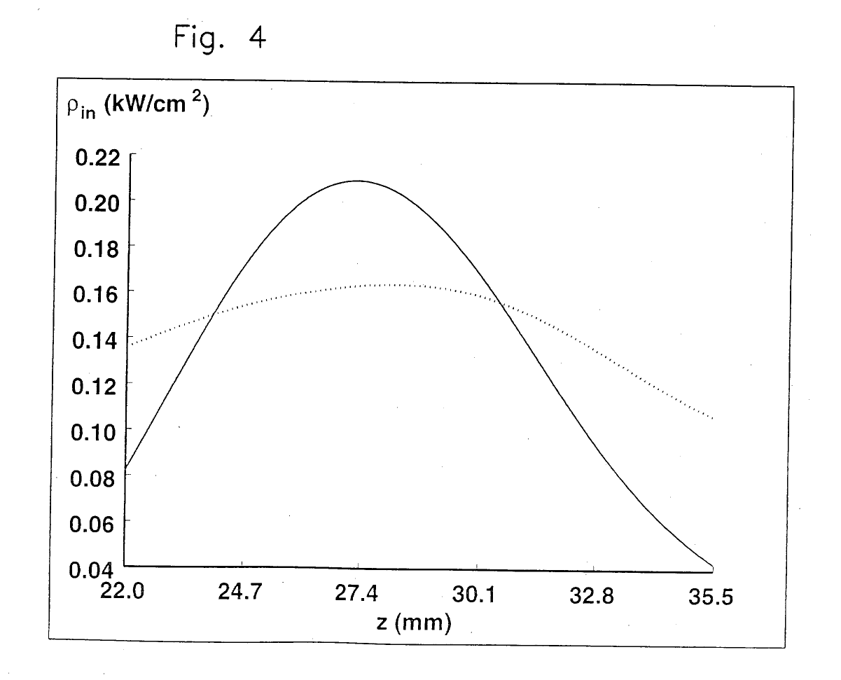

FIG. 4 shows the course of the wall losses in the inner conductor in axial, z-direction. The second advantageous effect of the variable depth d of the corrugations is apparent, that is, the deepening corrugations in the inner conductor in the center part of the resonator area homogenize the wall losses pᵢₙ in kW/cm², see the flat curve indicated be points with a maximum of about 0.16 kW/cm². The curve shown in full line represents the pᵢₙ over the z-axis along the center part L₂ of the resonator for an inner conductor with constant depth grooves, wherein a maximum of 0.22 kW/cm² is reached. For an effective cooling, it is better if the local maximum is less pronounced.

The section of the cooling circuit in the inner conductor may consist for example of a co-axial arrangement of two different tubes which are open at the distal end of the inner conductor so that a coolant flow is transferred at that point from one tube to the other in which the coolant flow is returned.

### LITERATURE

[1] Ch: T. Iatrou, S. Kern, A.B. Pavelyev, IEEE Transactions on Microwave Theory and Techniques 44, 56-64 (1996).

What is claimed is:

1. An inner conductor of a co-axial gyrotron with axial corrugations uniformly distributed about the inner circumference of said inner conductor, said inner conductor including an entrance funnel (L₁), a center part (L₂) and an exit funnel (L₃) and said corrugations being formed by axial grooves beginning in the entrance funnel (L₁) near the center part (L₂) and having increasing depth over the whole center part L₂ up to the exit funnel (L₃) of the resonator, which depth at least steadily decreases in the exit funnel (L₃).

2. An inner conductor according to claim 1, wherein the inner conductor, while having a wall thickness necessary for electrical purposes, is hollow from its beginning at least up to the end of the exit funnel (L₃) for the connection to a cooling circuit.

3. An inner conductor according to claim 1, wherein said corrugations which are distributed about the inner circumference of the inner conductor have a period with an arc length s, which is smaller than πRᵢₙ/m, wherein Rᵢₙ is the radius of the inner conductor at the end of the entrance funnel (L₁), in is the azimuthal index of the mode and 1 is the groove width of the corrugations, which is smaller than half the wavelength (1 <λ/2) of the frequency of the gyrotron.
